(19) United States
(12) Patent Application Publication
(10) Pub. No.: US 2006/0008104 A1
(43) Pub. Date: Jan. 12, 2006

(54) Sports board music

(76) Inventor: Brent David Sausser, Hollywood, SC (US)

Correspondence Address: Brent Sausser, 4946 Highway 162, Hollywood, SC, 29449, US

(21) Appl. No.: 10/888,922

(22) Filed: Jul. 12, 2004

(51) Int. Cl. H04R 1/02; G09F 27/00; H04R 9/06

(52) U.S. Cl. 381/334; 381/124

(57) ABSTRACT

Sports board music is a waterproof am/fin radio, MP3 player, or compact disc player designed to attach to a sports board i.e. (surfboards, snowboards, or wakeboards). Its main purpose is to entertain sports board riders while they are using their boards. It is designed to adhere to the sports board, and allows the rider to listen to music while operating his/her board. The radio, MP3 player, or compact disc player itself is very durable and is able to withstand harsh conditions.

### CROSS RERERENCE TO RELATED APPLICATIONS

Application # Title

20020042258 Ruggedized tradesworkers radio

This radio is designed for working conditions and by no means is intended for means of recreation purposes.

Application # Title

20030205951 Weatherproof retractable multi-media entertainment center

This is an entertainment center for waterproof conditions around the home and has no means of use on sports boards.

Application # Title

20020196953 Swimmers Ear

This is a waterproof radio designed for use by someone swimming or bathing and is not intended to adhere to a board for a sport boarder's entertainment. It is also listened to with headphones whereas the sports board radio is designed to have external speakers.

Patent # Title

4824139 Skateboard with audio entertainment device

This device is not meant for harsh conditions, and would fail if used in combination with a surfboard, snowboard, or wakeboard.

Patent # Title

4279342 Lunch box employing a built-in radio receiver

This built in radio is meant for lunch boxes not extreme sports.

Patent # Title

4362907 Combination automobile sun visor and radio and speaker assembly

This is meant for automobiles not extreme sports.

### STATEMENT REGARDING FEDERALLY SPONSORED RESEARCH OR DEVELOPMENT

N/A

### REFERENCE TO SEQUENCE LISTING

N/A

### BACKGROUND OF THE INVENTION

The present invention pertains to the sports board problem of not being able to listen to music on your sports board without having to worry about the radio, mp3 player, or the compact disc player's condition, whether it is worrying about it getting wet or worrying about it breaking due to harsh conditions.

### BRIEF SUMMARY OF THE INVENTION

The invention at issue is used to entertain sports board users (surfers, wakeboarders, and snowboarders), and provide them with a source of entertainment while using their sports board. This invention is an am/fin radio, mp3 player, or compact disc player that they can use that is weather proof to endure the tough conditions presented by the rider. It is made to adhere to their board, and provides them with am/fm radio capabilities, mp3 player, or compact disc player capabilities while they are using their sports board.

### BREIF DESCRIPTION OF THE SEVERAL VIEWS OF THE DRAWING

FIG. 1A This is a drawing of the present invention itself before it is attached to the sports board.

FIG. 2A This is a drawing of the invention attached to a surfboard, and is showing how the user will be able to use it.

FIG. 2B This is a drawing of the invention attached to a wakeboard, and is showing how the user will be able to use it.

FIG. 2C This is a drawing of the invention attached to a snowboard, and is showing how the user will be able to use it.

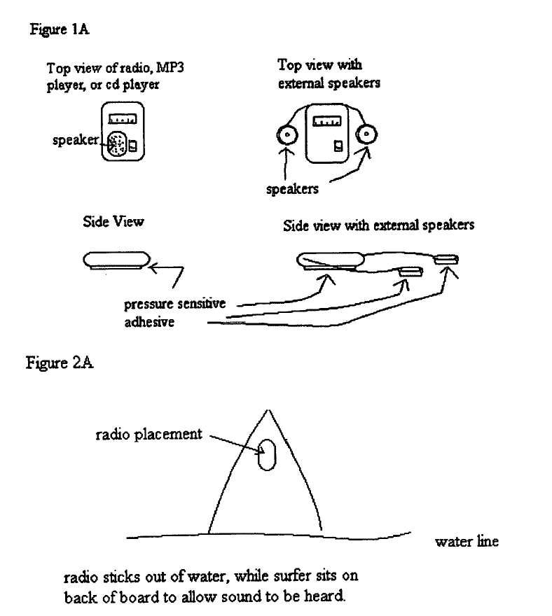

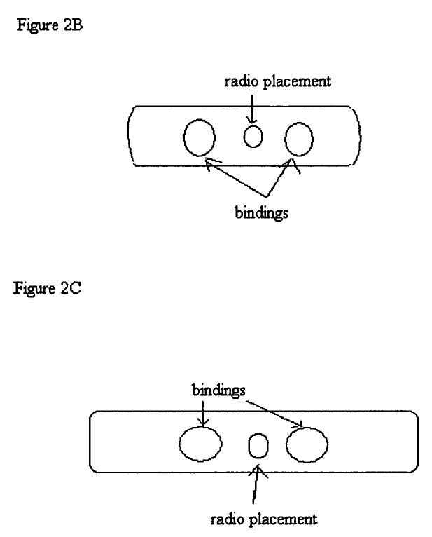

### DETAILED DESCRIPTION OF THE INVENTION

The invention being discussed is made by creating a totally submersible am/fm radio, MP3 player, or compact disc player that is durable in all weather conditions, and attaching an adhesive to it that will allow the user to attach it to his/her sports board. The radio or compact disc player itself is made of a weather proof material that is to protect it against water, dirt, and collision. The adhesive is a pressure sensitive adhesive that must be applied to a dry surface. The invention is to be applied to a sports board so that the user can use it during the use of their sports board.

1) What I claim as my invention is an am/fm radio, MP3 player, or compact disc player with waterproof speakers that can be attached with an adhesive to a sports board i.e. (surfboard, wakeboard, or snowboard) for the entertainment of the rider.

2) The am/fm radio as referred to in claim (1) is a weatherproof radio that endures the harshest weather conditions. Thus the radio is durable and waterproof (submersible in water).

3) The compact disc player as referred to in claim (1) is a weatherproof compact disc player that endures the harshest weather conditions. Thus the compact disc player is durable and waterproof (submersible in water).

4) The waterproof speakers as referred to in claim (1) are speakers durable enough to be submersed in water. These speakers can be separate from the radio or built in the radio itself.

5) The waterproof speakers as referred to in claim (4) are either attached to the radio, MP3 player, or compact disc player or are connected to it via weather proof wires.

6) The weather proof wires as referred to in claim (5) are those that will protect the wires from its outside elements.

7) The adhesive referred to in claim (1) is a pressure sensitive adhesive, and after it is applied to a dry surface it can uphold in harsh conditions.

8) The harsh conditions as mentioned in claim (7) refer to water, dirt, and collision.

9) The pressure sensitive adhesive referred to in claim (7) refers to a stick surface that adheres to dry surfaces, and when it dries it can withstand great pull force.

10) The am/fm radio referred to in claim (1) is a battery powered weatherproof radio with am station and fin station capabilities, which has manually operated controls.

11) The compact disc player as referred to in claim (1) is a weatherproof compact disc player that has the ability to play compact discs, which has manually operated controls.

12) The manually operated controls referred to in claim (10) are tuning capabilities and volume capabilities.

13) The manually operated controls referred to in claim (11) are track selection, pausing, volume, playing, stopping, rewinding, fast forwarding, and also may include such extra options as programming, and random capabilities.

14) The MP3 player as referred to in claim (1) is a weatherproof MP3 player that has the ability to play MP3s, which has manually operated controls.

15) The manually operated controls referred to in claim (14) are track selection, pausing, volume, playing, stopping, rewinding, fast forwarding, and also may include such extra options as programming, and random capabilities.
